(19) United States
(12) Patent Application Publication
(10) Pub. No.: US 2011/0320245 A1
(43) Pub. Date: Dec. 29, 2011

(54) Coupons for On-Demand Content

(75) Inventors: Bishnu Nayak, Saint Louis, MO (US); Trevor Lovett, Imperial, MO (US); Daniel Malee, Wheaton, IL (US)

(73) Assignee: AT&T INTELLECTUAL PROPERTY I, L.P., Reno, NV (US)

(21) Appl. No.: 12/824,979

(22) Filed: Jun. 28, 2010

(51) Int. Cl. G06Q 30/00

(52) U.S. Cl. 705/14.1

(57) ABSTRACT

A method includes receiving a coupon validation request associated with a user account and determining whether a coupon is valid based on the coupon validation request. Coupon data associated with the coupon is added to a valid coupon list associated with the user account when the coupon is valid. Transaction data is automatically compared to the valid coupon list to determine whether at least one coupon identified in the valid coupon list is applicable to at least one transaction. When two or more coupons identified in the valid coupon list are applicable to the at least one transaction, a first coupon is automatically selected to apply to the at least one transaction based on priorities associated with the two or more coupons. The first coupon is automatically applied to the at least one transaction.

### FIELD OF THE DISCLOSURE

The present disclosure is generally related to systems and methods of using coupons for on-demand content.

### BACKGROUND

Coupons can be used to encourage consumer to make purchases, which can increase revenue. For example, coupons can be used to encourage use of revenue generating services, such as accessing on-demand content. However, large-scale media distribution systems, such as cable television systems and Internet protocol television (IPTV) systems, may be complex, and introducing new features or functionality can be expensive and unexpected problems may arise. Thus, when an existing media distribution system does not have the capacity to process coupons, adding the ability to process coupons may be difficult.

### BRIEF DESCRIPTION OF THE DRAWINGS

FIG. 1 is a block diagram of a first particular embodiment of system to use coupons for on-demand content;

FIG. 2 is a flow chart of a first particular embodiment of method of using coupons for on-demand content;

FIG. 3 is a block diagram of a second particular embodiment of system to use coupons for on-demand content;

FIG. 4 is a ladder diagram of a second particular embodiment of method of using coupons for on-demand content;

FIG. 5 illustrates a first particular embodiment of a graphical user interface to facilitate use of coupons for on-demand content;

FIG. 6 illustrates a second particular embodiment of a graphical user interface to facilitate use of coupons for on-demand content;

FIG. 7 illustrates a third particular embodiment of a graphical user interface to facilitate use of coupons for on-demand content;

FIG. 8 illustrates a fourth particular embodiment of a graphical user interface to facilitate use of coupons for on-demand content;

FIG. 9 illustrates a fifth particular embodiment of a graphical user interface to facilitate use of coupons for on-demand content;

FIG. 10 is a block diagram of an illustrative embodiment of an Internet Protocol Television system; and

FIG. 11 is a block diagram of an illustrative embodiment of a general computer system.

### DETAILED DESCRIPTION

A coupon validation and redemption system is disclosed that enables an on-demand content provider to support use of coupons. The coupon validation and redemption system may be implemented using a common services architecture that is available and accessible via multiple user devices. The coupon validation and redemption system may enable use and redemption of coupons via multiple platforms, including paper coupons, via entry of coupon identifiers via a user interface of one or more of the user devices. The coupon validation and redemption system applies coupons during generation of a bill rather than during execution of a transaction. Thus, modification of a transaction system used by the on-demand content provider is not needed.

In a particular embodiment, a method includes receiving a coupon validation request associated with a user account. The method also includes determining whether a coupon is valid based at least partially on the coupon validation request. When the coupon is valid, coupon data associated with the coupon is added to a valid coupon list associated with the user account. Transaction data including information descriptive of at least one transaction associated with the user account is received. The transaction data is automatically compared to the valid coupon list to determine whether at least one coupon identified in the valid coupon list is applicable to the at least one transaction. When two or more coupons identified in the valid coupon list are applicable to the at least one transaction, a first coupon is automatically selected to apply to the at least one transaction based on priorities associated with the two or more coupons. The first coupon is automatically applied to the at least one transaction.

In a particular embodiment, a non-transitory, computer-readable medium includes instructions executable by a processor to cause the processor to determine whether a coupon is valid based at least partially on a coupon validation request associated with a user account. The computer-readable medium includes instructions executable by the processor to cause the processor to add coupon data associated with the coupon to a valid coupon list associated with the user account when the coupon is valid. The computer-readable medium includes instructions executable by the processor to cause the processor to compare transaction data to the valid coupon list to determine whether at least one coupon identified in the valid coupon list is applicable to the at least one transaction. The transaction data includes information descriptive of at least one transaction associated with the user account. The computer-readable medium includes instructions executable by the processor to cause the processor to select a first coupon to apply to the at least one transaction based on a priority of two or more coupons identified in the valid coupon list that are applicable to the at least one transaction. The computer-readable medium includes instructions executable by the processor to cause the processor to apply the first coupon to the at least one transaction.

In a particular embodiment, a system includes at least one processor and at least one memory accessible to the at least one processor. The at least one memory includes a coupon validation module executable by the at least one processor to determine whether a coupon is valid based at least partially on a coupon validation request associated with a user account and to add coupon data associated with the coupon to a valid coupon list associated with the user account when the coupon is valid. The at least one memory also includes a transaction module executable by the at least one processor to facilitate at least one transaction associated with the user account. The at least one memory also includes a billing module executable by the at least one processor during generation of a bill associated with the user account to compare transaction data to the valid coupon list to determine whether at least one coupon identified in the valid coupon list is applicable to the at least one transaction. The transaction data includes information descriptive of at least one transaction associated with the user account. The billing module is further executable by the at least one processor to select a particular coupon to apply to the at least one transaction based on a priority of two or more coupons identified in the valid coupon list that are applicable to the at least one transaction and to apply the particular coupon to the at least one transaction.

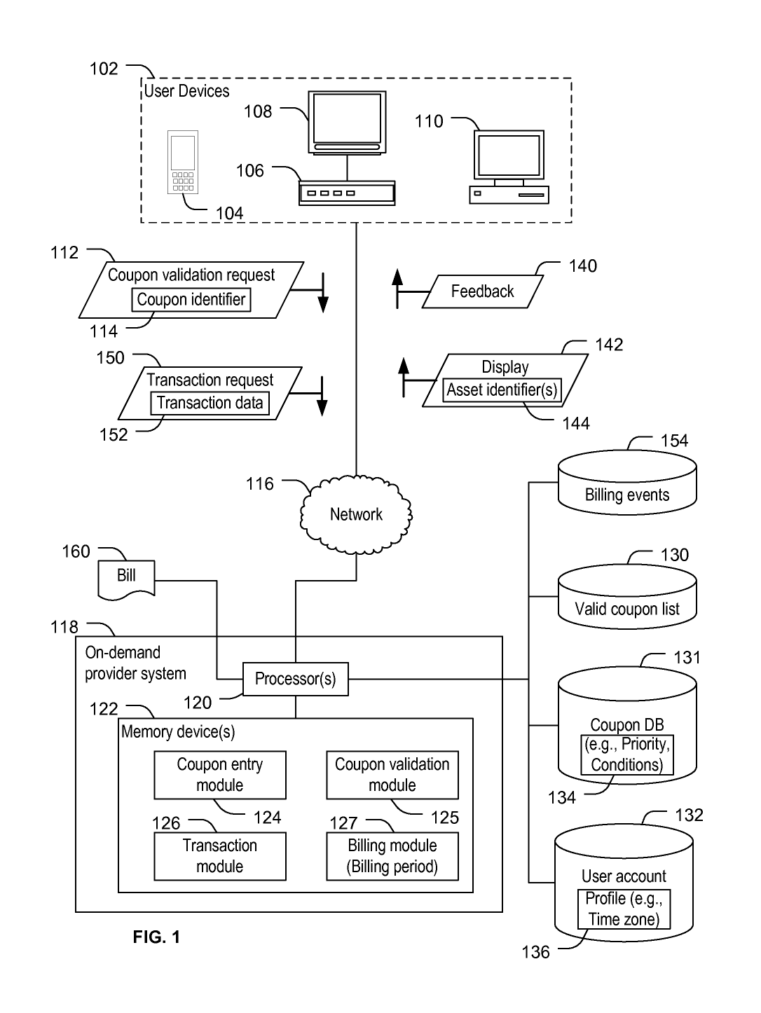

FIG. 1 is a block diagram of a first particular embodiment of system to use coupons for on-demand content. The system may include one or more user devices 102, such as a mobile device 104, a set top box device 106 coupled to a television display 108, or a computing device 110. The user devices 102 may be coupled via a network 116 to an on-demand provider system 118. For example, the on-demand provider system 118 may include one or more computing devices associated with an on-demand service provider, such as a video on-demand service provider or a pay-per-view service provider that provides on-demand media content via the network 116 to one or more of the user devices 102. To illustrate, the on-demand provider system 118 may be part of a cable television system, a satellite television system or an Internet protocol television (IPTV) system. The on-demand provider system 118 may include one or more processors 120 and one or more memory devices 122 accessible to the one or more processors 120. The memory devices 122 may include functional modules 124-127 which provide various services of the on-demand provider system 118. The functional modules 124-127 may be executable by the one or more processors 120 to provide services of the on-demand provider system 118 to users of the user devices 102.

In a particular embodiment, the functional modules 124-127 may include a coupon entry module 124. The coupon entry module 124 may be adapted to provide a user interface to one or more of the user devices 102 to enable a user to generate a request to validate a coupon. For example, one of the user devices 102 may send a coupon validation request 112 including a coupon identifier 114 via the network 116 to the on-demand provider system 118 using the GUI provided by the coupon entry module 124. The coupon identifier 114 may include information descriptive of the coupon to be validated. For example, the coupon identifier 114 may include bar code information, coupon code information, a text description, or other information used to identify a particular coupon. The coupon identifier may be input by the user via one or more of the user devices 102. For example, the user may select a coupon via a user interface displayed on the television display 108 to cause the set top box device 106 to automatically generate the coupon validation request 112 including the coupon identifier 114. In another example, the user may type or otherwise enter the coupon identifier 114 from a message that includes the coupon identifier 114, such as a paper coupon, an email message, a short message service (SMS) message, or another message used to distribute coupons to users of the on-demand provider system 118.

In response to the coupon validation request 112, the on-demand provider system 118 may implement a coupon validation module 125. The coupon validation module 125 may compare the coupon identifier 114 to information in a coupon database 131 to determine whether the coupon associated with the coupon identifier 114 is valid. In a particular embodiment, the coupon validation module 125 determines whether the coupon is valid based at least partially on information associated with a user account 132. The user account 132 may be determined based on information from the coupon validation request 112. When the coupon associated with the coupon identifier 114 is valid, the coupon validation module 125 may add coupon data identifying the coupon to a valid coupon list 130. When the coupon identifier 114 is not associated with a valid coupon, the coupon validation module 125 may not add the coupon data to the valid coupon list 130.

In a particular embodiment, the coupon validation module 125 determines whether the coupon is valid based at least partially on a profile 136 associated with the user account 132. For example, the profile 136 may include information about a time zone associated with the user account 132. To illustrate, the coupon may only be valid during a particular time period. Accordingly, the time zone associated with the user account 132 may be used to determine whether the coupon is valid for the particular user.

Whether the coupon identifier 114 is associated with a valid coupon or not, the coupon validation module 125 may send feedback 140 to the user via one or more of the user devices 102. The feedback 140 may inform the user whether the coupon associated with the coupon identifier 114 is valid or not, and may also provide other information. For example, when the coupon is not valid, the feedback 140 may include information about why the coupon is not valid. To illustrate, the feedback 140 may indicate that the coupon is expired, that the coupon identifier 114 is not recognized, that the coupon is not valid for the user account 132 (e.g., because of a location associated with the user account 132, because of a service level associated with the user account 132, because the coupon is associated with a different user account, and so forth), that the coupon has already been used, or that the coupon is invalid for some other reason. When the coupon is valid, the feedback 140 may include information indicating when the coupon will expire, what assets (e.g., on-demand content) can be purchased using the coupon, how the coupon will be applied (e.g., during a bill generation process), how to use the coupon, other information about the coupon, purchasable assets, or an on-demand provider system, or any combination thereof.

In a particular embodiment, the on-demand provider system 118 sends a display 142 including one or more asset identifiers 144 to one or more of the user devices 102 in response to determining that the coupon is valid. The asset identifiers 144 may identify assets available via the on-demand provider system 118 that are associated with the coupon. For example, the asset identifiers 144 may identify one or more video-on-demand assets or one or more pay-per-view assets associated with the coupon. To illustrate, the coupon may provide a discount toward purchasing a right to access particular video-on-demand content, such as a particular movie or a particular set of movies. As another illustrative example, the asset identifiers 144 may identify particular pay-per-view content that can be purchased at a discount based on the coupon.

In response to the display 142 or at a later time, a user associated with the user account 132 may determine to purchase an asset via the on-demand provider system 118. To implement the purchase, the user may use one of the user devices 102 to send a transaction request 150. The transaction request 150 may include transaction data 152 identifying the asset to be purchased. The transaction data 152 may also include other information used by the on-demand provider system 118 to implement the transaction. In response to the transaction request 150, the on-demand provider system 118 may implement a transaction module 126. The transaction module 126 may facilitate the transaction associated with a user account 132. For example, the transaction module 126 may generate a billing event 154 associated with the user account 132 to charge the user for the purchase of the asset.

At the end of the billing period or at another time when a bill 160 is to be generated for the user account 132, the on-demand provider system 118 may implement a billing module 127 to generate the bill 160. During generation of the bill 160 the billing module 127 may compare the billing events 154 with the valid coupon list 130 to determine whether at least one coupon identified in the valid coupon list 130 is applicable to at least one billing event 154 associated with the user account 132. The billing module 127 may select a particular coupon to apply to a particular transaction based on a priority of each coupon in the valid coupon list 130. For example, when two or more coupons are identified in the valid coupon list 130 that could be applicable to a particular transaction, the billing module 127 may select one of the two or more coupons based on a priority assigned to each coupon. The billing module 127 may apply the selected coupon to at least one transaction by adjusting one or more billing events 154 associated with the at least one transaction. The adjusted billing event or billing events may be identified in the bill 160 to show application of the coupon to the at least one transaction. In the particular embodiment, the billing module 127 does not receive user input to select the particular coupon from the valid coupon list 130 that is to be applied to a transaction. Rather, the billing module 127 operates in an “offline” capacity, such that the user devices 102 are not interacting with the on-demand provider system 118 regarding application of the coupon at the time that the coupon is selected to apply to the transaction. For example, the billing module 127 may select the particular coupon and apply the particular coupon to the at least one transaction in response to expiration of the billing period or at another time when the bill 160 is to be generated, such as at closing of the user account 132.

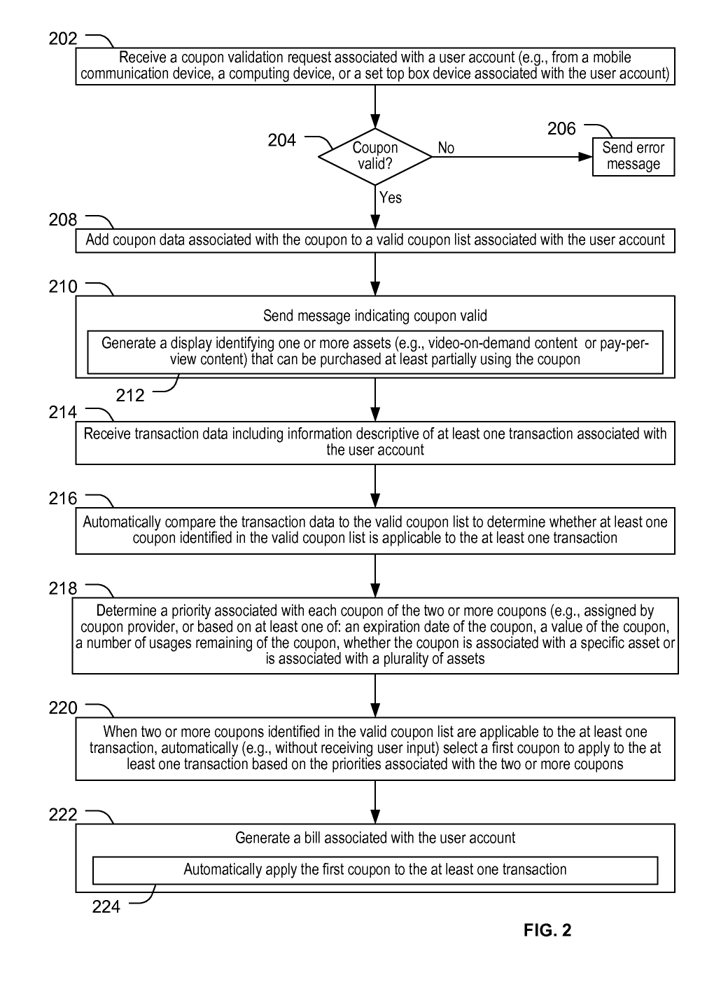

FIG. 2 is a flow chart of a first particular embodiment of a method of using coupons for on-demand content. The method includes, at 202, receiving a coupon validation request associated with a user account. For example, the coupon validation request may be received from a mobile communication device (e.g., a mobile telephone), a computing device (e.g., a desktop computer, a laptop computer or a tablet computer), or a set top box device associated with the user account. The method may also include, at 204, determining whether the coupon is valid. When the coupon is not valid, an error message may be sent indicating that the coupon is not valid, at 206. When the coupon is valid, coupon data associated with the coupon may be added to a valid coupon list associated with the user account, at 208. The method may also include, at 210, sending a message indicating that the coupon is valid to a user. For example, a display identifying one or more assets that can be purchased using the coupon may be generated and provided to the user, at 212. To illustrate, the display may identify one or more video-on-demand content assets or one or more pay-per-view assets that can be purchased using the coupon.

In a particular embodiment, the method includes, at 214, receiving transaction data including information descriptive of at least one transaction associated with the user account. For example, the at least one transaction may include purchasing a right to access one or more media assets available via an on-demand provider system, such as the on-demand provider system 118 in FIG. 1. The one or more media assets may include video-on-demand content, pay-per-view content or other on-demand content. The transaction data may include information descriptive of the transaction. The transaction may or may not be related to a coupon in the valid coupon list. For example, when the transaction data is received, the transaction may be processed without regard to whether a coupon applies to the transaction.

The method may also include, at 216, automatically comparing the transaction data to the valid coupon list associated with the user account to determine whether at least one coupon identified in the valid coupon list is applicable to the at least one transaction. In a particular embodiment, the transaction data is compared to the valid coupon list after one or more transactions are processed. For example, the transaction data may be compared to the valid coupon list after the user has been granted a right to access a purchased asset. To illustrate, the transaction data may be compared to the valid coupon list as part of a periodic reconciliation process. In another illustrative example, the transaction data may be compared to the valid coupon list as part of a bill generation process (e.g., at the end of a billing period).

The method may also include, at 218, determining a priority associated with each coupon in the valid coupon list. For example, the priority may be assigned by a coupon provider. In another example, the priority may be based on an expiration date of the coupon, a value of the coupon, a number of uses remaining for the coupon, whether the coupon is associated with a particular asset (e.g., a particular movie) or is associated with a general class of assets or a variety of assets (e.g., a particular genre of movies). For example, coupons that have an earlier expiration date may be used before, and therefore may be assigned to have priority over, coupons that have a later expiration date. Alternately, coupons having a later expiration date may be used prior to, and therefore may be assigned to have priority over, coupons with an earlier expiration date. In another example, priority may be assigned to each coupon based on the value of the coupon. To illustrate, coupons having a higher value may be assigned higher priority or a lower priority than coupons having a lower value. In another example, coupons that have multiple usages remaining may be assigned a higher priority than coupons that have only one use remaining. Alternately, coupons that have only one use remaining may be assigned a higher priority than coupons that have multiple uses remaining. In another example, a coupon associated with a specific asset (e.g., a particular movie or pay-per-view event) may be assigned a higher priority than a coupon associated with more than one asset (e.g., a set of movies or pay-per-view events). To illustrate, when the valid coupon list includes a first coupon associated with a particular movie and second coupon associated with a genre of movies that includes the particular movie, the first coupon may be given a higher priority. Thus, the first coupon associated with the particular movie may be assigned a higher priority than the second coupon that is associated with a genre of movies. Alternately, the second coupon associated with the genre of movies may be assigned a higher priority than the first coupon associated with the particular movie.

When two or more coupons identified in the valid coupon list are applicable to the at least one transaction, the method may include, at 220, automatically (e.g., without receiving user input) selecting a first coupon to apply to the at least one transaction based on priorities associated with the coupons. The method may also include, at 222, generating a bill associated with the user account. In a particular embodiment, the selected coupon may be applied to the at least one transaction automatically during generation of the bill associated with the user account, at 224. That is, the coupon may not be applied to the transaction in response to receiving the transaction data. Rather, the coupon may be applied during generation of the bill, e.g., at the end of the billing period or at another time when a bill is to be generated.

By applying the coupons during generation of the bill rather than during execution of the transaction, coupons may be used with on-demand provider systems that are closed or not otherwise able to implement coupons. For example, closed systems that do not support coupon functionality during execution of transactions may be provided with the ability to support coupons by using bill generation techniques to apply coupons during generation of the bill. To illustrate, Internet protocol television (IPTV) systems may use complex interactions between multiple service providers, multiple computing systems and large distributive networks to provide on-demand content. Modifying work flows of IPTV systems to accommodate coupons may be challenging. However, modifying bill reconciliation associated with an IPTV system may be simpler and may provide an opportunity to enable coupon functionality for purchase of on-demand assets via the IPTV system.

A coupon validation and redemption system of an on-demand provider system may be implemented using a common services architecture that is available and accessible via multiple user devices, such as the user devices 102 of FIG. 1. The coupon validation and redemption system may enable use and redemption of coupons via multiple platforms, including paper coupons, via entry of coupon identifiers via a user interface of one or more of the user devices 102. Since the coupon validation and redemption system may be used with the on-demand provider system, targeted coupons can be supported. For example, an IPTV system may have a user account associated with one or more user devices. A coupon targeting a user associated with the user account may be supported by making the coupon valid only for the user account or only for a particular set or type of user accounts. To illustrate, a particular coupon may be valid only for users having a predefined set of services.

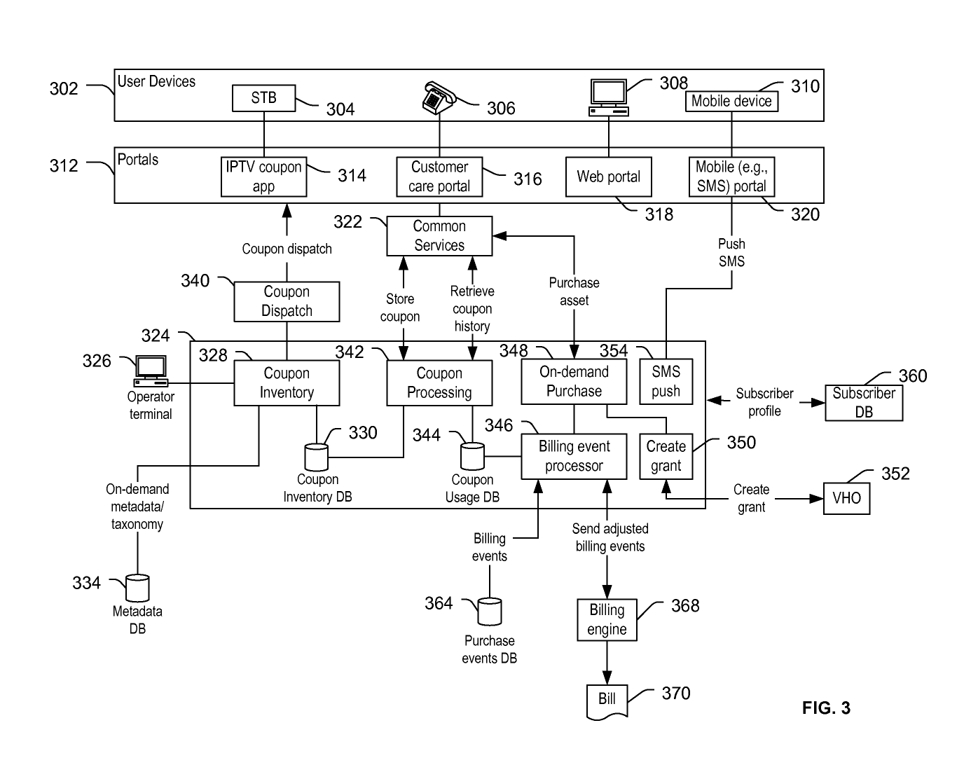

FIG. 3 is a block diagram of a second particular embodiment of system to use coupons for on-demand content. The system includes a plurality of user devices 302, such as a set-top box (STB) device 304, a landline telephone 306, a computing device 308, and a mobile device 310. The user devices 302 may interact via one or more portals 312 with an on-demand provider system 324. The portals 312 may include an IPTV coupon application 314 accessible to a user of the set-top box device 304 via a user interface presented on a television display. For example, the IPTV coupon application 314 may be downloadable by the set-top box device 304 to implement coupon functionality. In another example, the portals 312 may include a customer care portal 316. The customer care portal 316 may include an interactive voice response system or live customer support system. The customer care portal 316 may enable voice interaction between a user and the on-demand provider system 324. For example, the user may be able to provide a coupon identifier to implement the coupon service via a landline or mobile telephone call (e.g., via the landline telephone 306 or the mobile device 310). In another example, the portals 312 may include a web portal 318. The web portal 318 may be accessible to a computing device, such as the computing device 308 or the mobile device 310, via a network connection to enable use of the coupon service. In another example, the portals 312 may include a mobile portal 320. For example, the mobile portal 320 may be accessible via the mobile device 310 using a data service or a messaging service, such as a short messaging service (SMS).

The portals 312 may interact with the on-demand provider system 324 via one or more common services 322. The common services 322 may facilitate communication of one or more of the portals 312 and the on-demand provider system 324 and components of the on-demand provider system 324. For example, the common services 322 may include a service oriented architecture (SOA) that facilitates communication between the portals 312 and the on-demand provider system 324 by providing data conversion, protocol conversion, or other middleware-type communication services.

The on-demand provider system 324 may include a coupon inventory system 328. The coupon inventory system 328 may be updated via an operator terminal 326. The coupon inventory system 328 may manage a coupon inventory database 330 that includes coupon data associated with valid coupons. For example, the coupon inventory database 330 may include terms and conditions as well as identifying information associated with the valid coupons. For example, terms and conditions may include limitations on who may use the coupons, limitations on when the coupons can be used, and other business rules or limitations on use of and validity of the coupons. To illustrate, the coupon inventory database 330 may identify an expiration date of a particular coupon. Additionally, the coupon inventory database 330 may identify particular assets that can or that cannot be purchased using the particular coupon. The coupon inventory system 328 may have access to a metadata database 334 that includes metadata and taxonomy information associated with on-demand content. For example, the metadata database 334 may include catalog information identifying each on-demand asset available via the on-demand provider system 324. To illustrate, the catalog information may include titles, times, genres, descriptive information, other metadata or identifying information, or any combination thereof, which may be used by the coupon inventory system 328 to catalog the on-demand content and to identify on-demand content to which the particular coupon applies.

The coupon inventory system 328 may be used to facilitate distribution (e.g., dispatching) of the coupons. For example, the coupon inventory system 328 may send a coupon dispatch message 340 via the one or more portals 312 to one or more of the user devices 302 to inform a user of the availability of a coupon. In another example, the coupon inventory system 328 may send the coupon dispatch message 340 via another distribution system, such as via a paper coupon sent by post or via a paper coupon sent to another advertiser.

The on-demand provider system 324 may also include a coupon processing system 342. The coupon processing system 342 may have access to the coupon inventory database 330 and may be accessible to the user devices 302 via the portals 312 and the common services 322. The user devices 302 may access the coupon processing system 342 to provide information identifying a coupon. The coupon processing system 342 may validate the coupon and identify the coupon in a coupon usage database 344. For example, the coupon usage database 344 may include a valid coupon list, such as the valid coupon list 130 of FIG. 1. To illustrate, the coupon usage database 344 may include information identifying a particular subscriber and a particular coupon that has been validated by the coupon processing system 342 in response to the subscriber sending a coupon validation request from one or more of the user devices 302. The coupon may be validated only for the particular subscriber. For example, the coupon usage database 344 may identify a particular subscriber account that the coupon has been validated for. The coupon may be validated for the particular subscriber account by comparing conditions or business rules associated with the coupon to a subscriber profile from a subscriber database 360.

The on-demand provider system 324 may also include an on-demand purchase system 348. The on-demand purchase system 348 may enable access to a particular on-demand asset by sending a create grant message 350 to a video head-end office (VHO) 352 associated with a particular user. In response to the create grant message 350, the video head-end office 352 may enable one or more of the user devices 302 to access the purchased asset. In a particular embodiment, the on-demand purchase system 348 may send a purchased asset via the common services 322 to the one or more user devices 302. In another particular embodiment, the on-demand purchase system 348 interacts via the common services 322 and the portals 312 with the user devices 302 to execute a transaction to purchase the on-demand asset, then authorizes the VHO 352 to send the purchased asset to the one or more user devices via the create grant message 350.

The on-demand provider system 324 may also include a short message service (SMS) push system 354. The SMS push system 354 may facilitate interaction of the on-demand provider system 324 with the mobile device 310 via SMS messaging to facilitate transactions.

When a subscriber purchases an on-demand asset, the on-demand purchase system 348 may send information to a billing event processor 346 to generate a billing event in response to the transaction. The billing event may be stored at a purchase events database 364.

When a bill 370 is to be generated, a billing engine 368 may interact with the billing event processor 346 to determine charges associated with the subscriber account. For example, the billing event processor 346 may access the list of coupons associated with the subscriber account from the coupon usage database 344 and may access billing events from the purchase events database 364. The billing event processor 346 may compare the list of valid coupons associated with the subscriber account to the billing events associated with the subscriber account to determine whether any valid coupon can be applied to a particular transaction of the billing events. When a coupon can be applied, the billing engine 368 applies the coupon to the billing event to generate an adjusted billing event. When more than one coupon can be applied, the billing engine 368 selects one or more coupons to be applied to the transaction based on priorities associated with the coupons.

The billing event processor 346 sends the adjusted billing event or adjusted billing events to the billing engine 368. The billing engine 368 generates the bill 370 based on the adjusted billing events and other billing events to which no coupon applied.

A user may access a list of coupons applied via the common services 322 as a coupon history. The coupon history may be stored in the coupon usage database 344 along with the list of valid coupons associated with the subscriber account.

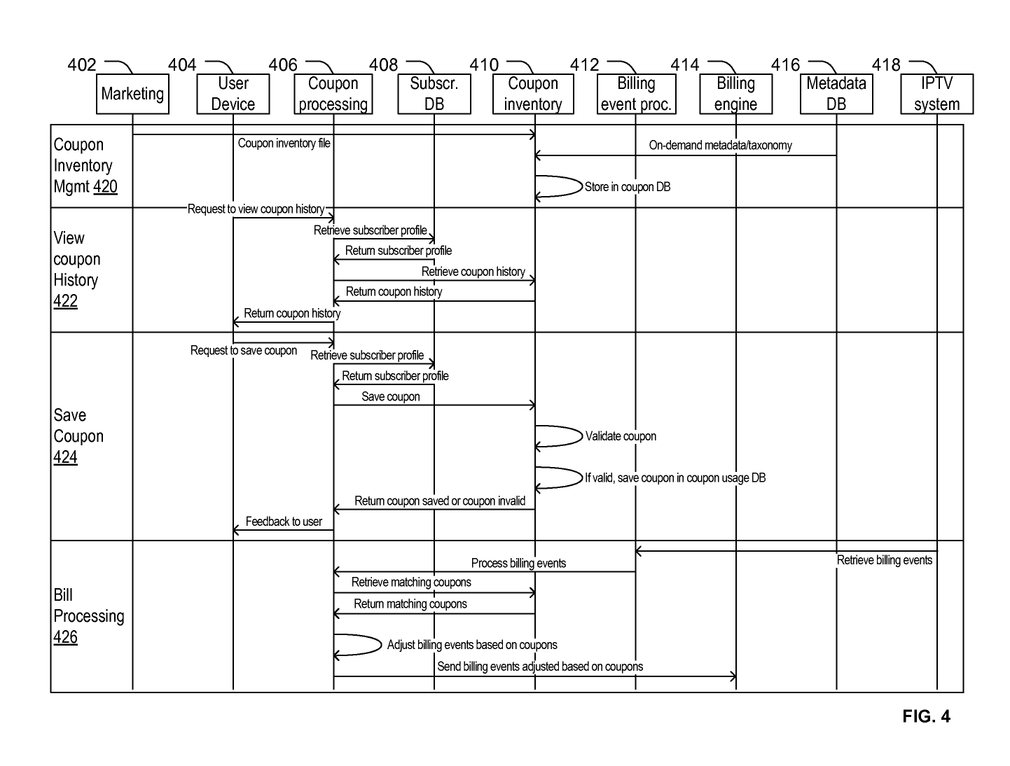

FIG. 4 is a ladder diagram of a second particular embodiment of method of using coupons for on-demand content. Messaging and dataflow between components of an on-demand provider system and one or more other systems are illustrated using the ladder diagram. For example, the systems may include a marketing system 402, a user device 404, a coupon processing system 406, a subscriber database 408, a coupon inventory system 410, a billing event processing system 412, a billing engine 414, a metadata database 416, and an IPTV system 418. The systems may interact via messaging to facilitate use of coupons for on-demand content in the IPTV system 418. Interactions between the systems are illustrated in phases, including a coupon inventory management phase 420, a view coupon history phase 422, a save coupon phase 424, and a bill processing phase 426.

In a particular embodiment, during the inventory management phase 420, the marketing system 402 may be used to generate or modify a coupon inventory. For example, the marketing system 402 may provide information including a coupon inventory file to the coupon inventory system 410. The coupon inventory system 410 may be used to implement a coupon service in the IPTV system 418. For example, the coupon inventory system 410 may include the coupon inventory system 328 of FIG. 3. In response to receiving the coupon inventory file, the coupon inventory system 410 may access the metadata database 416 to retrieve on-demand metadata and taxonomy information associated with on-demand assets identified in the coupon inventory file. The coupon inventory system 410 may also store the coupon data in a coupon database, such as the coupon inventory database 330 illustrated in FIG. 3.

In the view coupon history phase 422, the coupon processing system 406 may receive a request to view a coupon history from the user device 404. For example, the user device 404 may send the view coupon history request via a user interface provided via one or more portals or common services such as the portals 312 and common services 322 illustrated in FIG. 3. In response to the view coupon history request, the coupon processing system 406 may retrieve a subscriber profile associated with the user device 404 from the subscriber database 408. The subscriber database 408 may return the subscriber profile to the coupon processing system 406, and the coupon processing system 406 may retrieve coupon history information from the coupon inventory system 410. For example, the coupon inventory system 410 may access a coupon usage database, such as the coupon usage database 344 illustrated in FIG. 3. The coupon inventory system 410 may return the coupon history information associated with the subscriber profile to the coupon processing system 406. The coupon processing system 406 may return the coupon history to the user device 404. For example, the coupon processing system 406 may provide a graphical user interface including the coupon history information to the user device 404.

In the save coupon phase 424, the user device 404 may send a request to save a coupon to the coupon processing system 406. For example, the request to save the coupon may be a coupon validation request, such as the coupon validation request 112 of FIG. 1. In response to the request to save the coupon, the coupon processing system 406 may retrieve a subscriber profile of a subscriber associated with the user device 404 from the subscriber database 408. The subscriber database 408 may return the subscriber profile to the coupon processing system 406. The coupon processing system 406 may send the coupon information to the coupon inventory system 410 along with information from the subscriber profile. The coupon inventory system 410 may determine whether the coupon is valid and, if the coupon is valid, may save the coupon into the coupon usage database. The coupon inventory system 410 may return information indicating whether the coupon is valid to the coupon processing system 406. The coupon processing system 406 may provide feedback to the user via the user device 404 indicating that the coupon is invalid or that the coupon was saved to the coupon usage database in a valid coupon list.

During the bill processing phase 426, after transactions associated with the user account have occurred and after one or more coupons have been saved to a valid coupon list, a billing period may expire or a bill may be generated for some other reason. The billing event processing system 412 may retrieve billing events from the IPTV system 418. The billing event processing system 412 may send a request to process the billing events to the coupon processing system 406. The coupon processing system 406 may determine whether any coupons can be applied to particular billing events by retrieving the valid coupon list from the coupon inventory system 410. The coupon inventory system 410 may send coupon data for matching coupons to the coupon processing system 406. The coupon processing system 406 may generate adjusted billing events based on the coupons and may send the adjusted billing events based on the coupons to the billing engine 414, which may generate a bill based on the adjusted billing events.

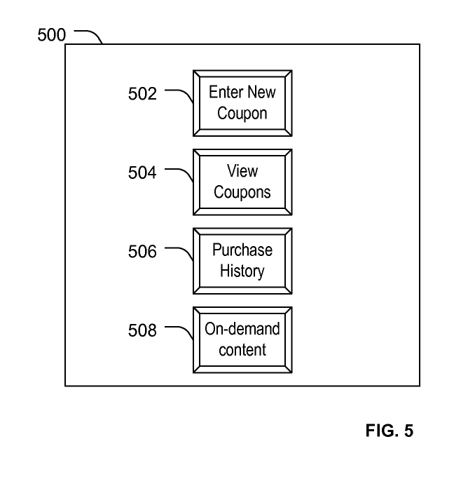

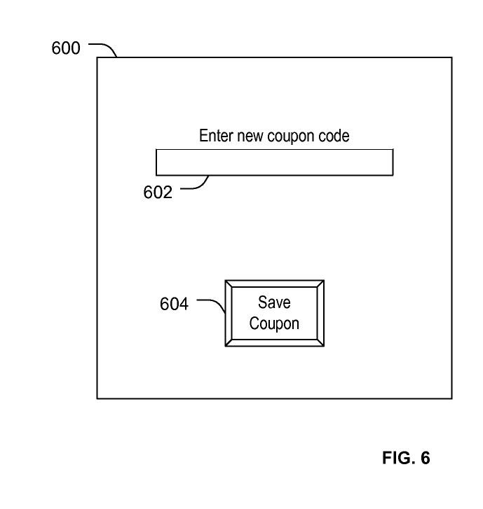

FIG. 5 illustrates a first particular embodiment of a graphical user interface (GUI) 500 to facilitate use of coupons for on-demand content. The GUI 500 may include a plurality of selectable options associated with providing a coupon service, associated with providing on-demand content, or both. For example, the GUI 500 may include an enter new coupon selectable option 502 that is selectable to enable entry of a new coupon. For example, selection of the enter new coupon selectable option 502 may cause an on-demand system to implement a coupon entry module, such as the coupon entry module 124 illustrated in FIG. 1. In response to selection of the enter new coupon selectable option 502, the user may be provided with a second GUI, such as a GUI 600 illustrated in FIG. 6, that enables the user to input information associated with a new coupon to generate a coupon validation request.

The GUI 500 may also include a view coupons selectable option 504. Selection of the view coupons selectable option 504 may cause the on-demand system to generate a list of previously validated coupons associated with a user account. For example, the on-demand system may display a valid coupon list associated with the user account.

The GUI 500 may also include a purchase history selectable option 506. Selection of the purchase history selectable option 506 may cause the on-demand system to generate a list of previous purchases associated with the user account. A list of previous purchases may include only content purchased or associated with a coupon or may include all purchases associated with a user account within a particular timeframe.

The GUI 500 may also include an on-demand content selectable option 508. Selection of the on-demand content selectable option 508 may cause the on-demand system to generate a list or catalog display of on-demand content available to the user via the user account. In particular embodiments, the GUI 500 may include more or fewer selectable options. For example, the GUI 500 may include selectable options to access other features of the on-demand system.

FIG. 6 illustrates a second particular embodiment of a graphical user interface (GUI) 600 to facilitate use of coupons for on-demand content. The GUI 600 includes an input element 602 to enable a user to input a new coupon code to be validated. The input element 602 may include one or more text entry boxes, pull-down menus, or another input mechanism that enable the user to enter a coupon code. The GUI 600 may also include a selectable save coupon option 604 to save the coupon associated with the coupon code provided via the input element 602. In response to selection of the save coupon option 604, the on-demand system may generate a coupon validation request including the coupon code and send the coupon validation request to a coupon validation module, such as the coupon validation module 125 illustrated in FIG. 1.

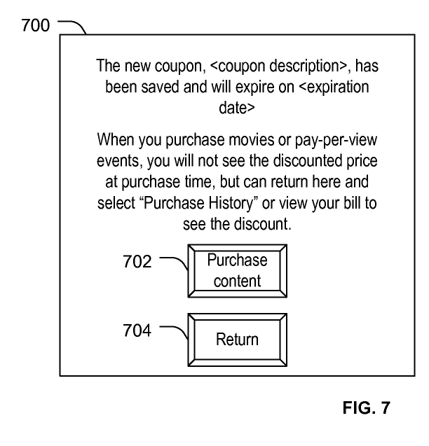

FIG. 7 illustrates a third particular embodiment of a graphical user interface (GUI) 700 to facilitate use of coupons for on-demand content. In a particular embodiment, the GUI 700 is provided in response to a valid coupon being provided from the user. For example, when a coupon is validated, the GUI 700 may be sent to a user device indicating that the coupon has been saved (e.g., added to a valid coupon list). The GUI 700 may also include information descriptive of the coupon, such as when the coupon will expire. The GUI 700 may also include a purchase content selectable option 702 that provides access to content that can be purchased using the coupon. For example, in response to selection of the purchase content selectable option 702, the on-demand system may send a display identifying on-demand assets that can be purchased using the coupon. When the user does not desire to make a purchase using the coupon at the particular time, the user may select a return option 704 to return to a previous screen or to remove the GUI 700 from the display.

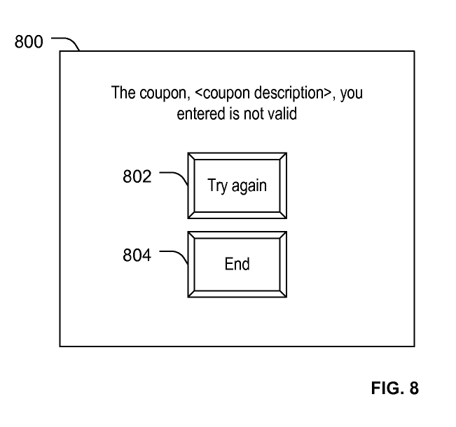

FIG. 8 illustrates a fourth particular embodiment of a graphical user interface (GUI) 800 to facilitate use of coupons for on-demand content. The GUI 800 may be displayed in response to a coupon validation system determining that a coupon code provided by a user is not valid or is not valid for the particular user. For example, the GUI 800 may be provided in response to an invalid entry being provided via the input element 602 of FIG. 6. In a particular embodiment, the GUI 800 includes information indicating why the coupon is not valid. For example, the coupon may be invalid because a user account of the particular user is not enabled to use the coupon, an expiration date of the coupon due has passed, the coupon code provided by the user is not recognized, or another reason. The GUI 800 may include a selectable try again option 802 to enable the user to try entering the coupon code again. Selection of the try again option 802 may cause the GUI 600 of FIG. 6 to be displayed, allowing the user to reenter the coupon code. The GUI 800 may also include a selectable end option 804 to terminate entry of coupon codes.

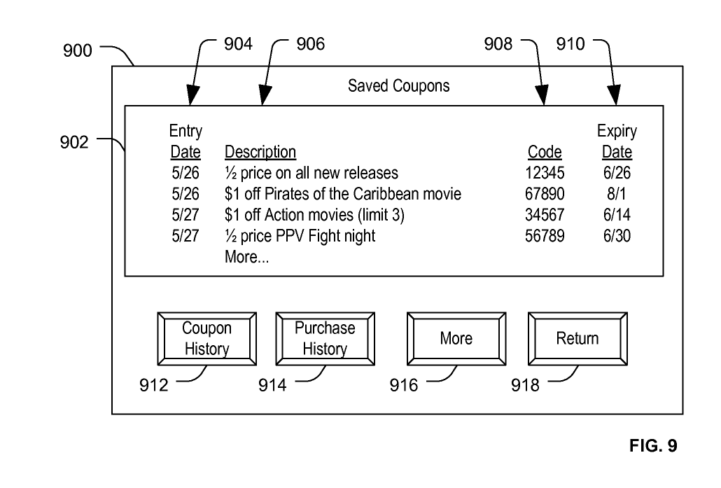

FIG. 9 illustrates a fifth particular embodiment of a graphical user interface (GUI) 900 to facilitate use of coupons for on-demand content. In the particular embodiment illustrated in FIG. 9, the GUI 900 includes a saved coupon list (or valid coupon list) associated with a user account. The saved coupon list is displayed via a text display area 902. In other embodiments, the text display area 902 of the GUI 900 may include other information, such as a coupon history, a purchase history, or other information associated with the user account.

In a particular embodiment illustrated in FIG. 9, the text display area 902 includes an entry date 904 associated with each coupon in the saved coupon list. The text display area 902 also includes a description 906 of each coupon in the saved coupon list. The text display area 902 also includes a coupon code 908 associated with each saved coupon and an expiration date 910 of each saved coupon.

The GUI 900 may include one or more user selectable options to enable the user to modify information displayed in the GUI 900 or to enable the user to navigate to a different screen. For example, the GUI 900 may include a selectable more option 916 enabling the user to view more coupons from the saved coupon list. In another example, the GUI 900 may include a selectable coupon history option 912. Selection of the coupon history option 912 may cause the text display area 902 to display information about coupons that have been applied to the user account. In another example, the GUI 900 may include a selectable purchase history option 914. Selection of the purchase history option 914 may cause the text display area 902 to display a history of purchases made via the user account. The GUI 900 may also include a selectable return option 918. Selection of the return option 918 may cause the display to change to a previous screen, such as the GUI 500 of FIG. 5, the GUI 600 of FIG. 6, the GUI 700 of FIG. 7, or the GUI 800 of FIG. 8.

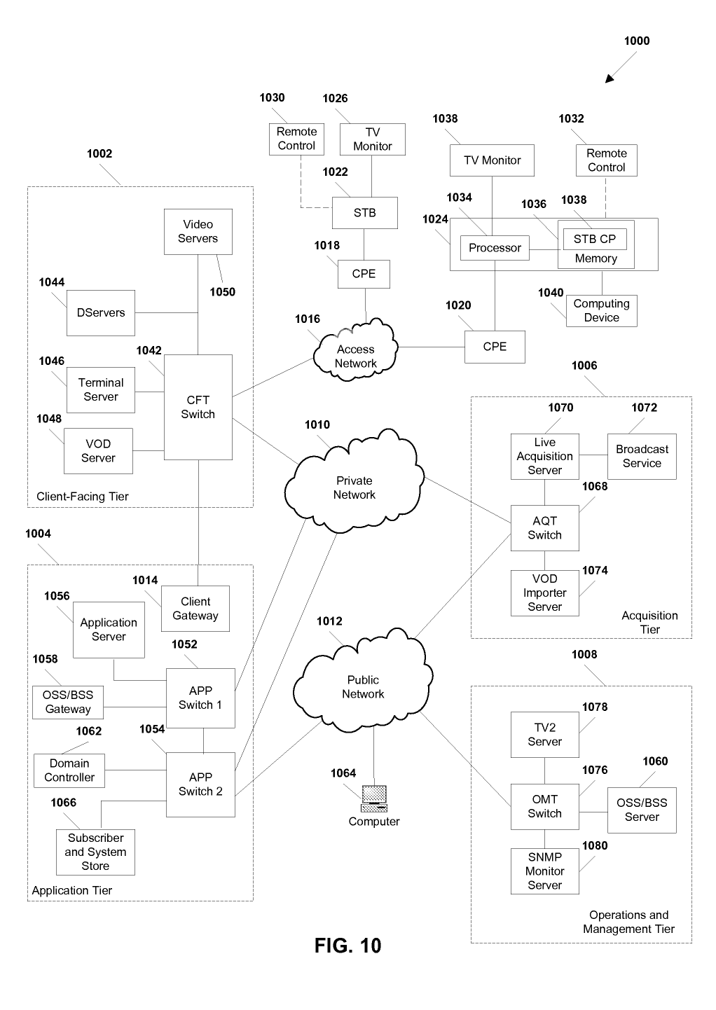

Referring to FIG. 10, an illustrative embodiment of an Internet Protocol Television (IPTV) system is illustrated and is generally designated 1000. As shown, the IPTV system 1000 can include a client facing tier 1002, an application tier 1004, an acquisition tier 1006, and an operations and management tier 1008. Each tier 1002, 1004, 1006, 1008 is coupled to a private network 1010; to a public network 1012, such as the Internet; or to both the private network 1010 and the public network 1012. For example, the client-facing tier 1002 can be coupled to the private network 1010. Further, the application tier 1004 can be coupled to the private network 1010 and to the public network 1012. The acquisition tier 1006 can also be coupled to the private network 1010 and to the public network 1012. Additionally, the operations and management tier 1008 can be coupled to the public network 1012.

As illustrated in FIG. 10, the various tiers 1002, 1004, 1006, 1008 communicate with each other via the private network 1010 and the public network 1012. For instance, the client-facing tier 1002 can communicate with the application tier 1004 and the acquisition tier 1006 via the private network 1010. The application tier 1004 can communicate with the acquisition tier 1006 via the private network 1010. Further, the application tier 1004 can communicate with the acquisition tier 1006 and the operations and management tier 1008 via the public network 1012. Moreover, the acquisition tier 1006 can communicate with the operations and management tier 1008 via the public network 1012. In a particular embodiment, elements of the application tier 1004, including, but not limited to, a client gateway 1014, can communicate directly with the client-facing tier 1002.

The client-facing tier 1002 can communicate with user equipment via an access network 1016, such as an Internet Protocol Television (IPTV) access network. In an illustrative embodiment, customer premises equipment (CPE) 1018, 1020 can be coupled to a local switch, router, or other device of the access network 1016. The client-facing tier 1002 can communicate with a first representative set-top box device 1022 at a first customer premise via the first CPE 1018 and with a second representative set-top box device 1024 at a second customer premise via the second CPE 1020. The CPE 1018, 1020 can include routers, local area network devices, modems, such as digital subscriber line (DSL) modems, any other suitable devices for facilitating communication between a set-top box device and the access network 1016, or any combination thereof.

In a particular embodiment, the client-facing tier 1002 can be coupled to the CPE 1018, 1020 via fiber optic cables. Alternatively, the CPE 1018, 1020 can be digital subscriber line (DSL) modems that are coupled to one or more network nodes via twisted pairs, and the client-facing tier 1002 can be coupled to the network nodes via fiber-optic cables. Each set-top box device 1022, 1024 can process data received via the access network 1016, via an IPTV software platform, such as Microsoft® TV IPTV Edition.

The first set-top box device 1022 can be coupled to a first external display device, such as a first television monitor 1026, and the second set-top box device 1024 can be coupled to a second external display device, such as a second television monitor 1028. Moreover, the first set-top box device 1022 can communicate with a first remote control 1030, and the second set-top box device 1024 can communicate with a second remote control 1032. The set-top box devices 1022, 1024 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 1022, 1024 can receive data, video, or any combination thereof, from the client-facing tier 1002 via the access network 1016 and render or display the data, video, or any combination thereof, at the display device 1026, 1028 to which it is coupled. In an illustrative embodiment, the set-top box devices 1022, 1024 can include tuners that receive and decode television programming signals or packet streams for transmission to the display devices 1026, 1028. Further, the set-top box devices 1022, 1024 can include a STB processor 1034 and a STB memory device 1036 that is accessible to the STB processor 1034. In one embodiment, a computer program, such as the STB computer program 1038, can generate a coupon validation request to request validation of a coupon. For example, the set top box 106 of FIG. 1 may include the STB computer program 1038 and may submit the coupon validation request 112 via the network 116. In another illustrative embodiment, a user computing device 1040, such as a personal computer, laptop or mobile device can send a coupon validation request via the public network 1012.

In an illustrative embodiment, the client-facing tier 1002 can include a client-facing tier (CFT) switch 1042 that manages communication between the client-facing tier 1002 and the access network 1016 and between the client-facing tier 1002 and the private network 1010. As illustrated in FIG. 10, the CFT switch 1042 is coupled to one or more data servers, such as D-servers 1044, that store, format, encode, replicate, or otherwise manipulate or prepare video content for communication from the client-facing tier 1002 to the set-top box devices 1022, 1024. The CFT switch 1042 can also be coupled to a terminal server 1046 that provides terminal devices with a connection point to the private network 1010. In a particular embodiment, the CFT switch 1042 can be coupled to a video-on-demand (VOD) server 1048 that stores or provides VOD content imported by the IPTV system 1000. Further, the CFT switch 1042 is coupled to one or more video servers 1050 that receive video content and transmit the content to the set-top box devices 1022, 1024 via the access network 1016.

In an illustrative embodiment, the client-facing tier 1002 can communicate with a large number of set-top boxes, such as the representative set-top box devices 1022, 1024 over a wide geographic area, such as a regional area, a metropolitan area, a viewing area, a designated market area or any other suitable geographic area, market area, or subscriber or customer group that can be supported by networking the client-facing tier 1002 to numerous set-top box devices. In a particular embodiment, the CFT switch 1042, or any portion thereof, can include a multicast router or switch that feeds one or more video streams from a video server to multiple set-top box devices.

As illustrated in FIG. 10, the application tier 1004 can communicate with both the private network 1010 and the public network 1012. The application tier 1004 can include a first application tier (APP) switch 1052 and a second APP switch 1054. In a particular embodiment, the first APP switch 1052 can be coupled to the second APP switch 1054. The first APP switch 1052 can be coupled to an application server 1056 and to an OSS/BSS gateway 1058. In a particular embodiment, the application server 1056 can provide applications to the set-top box devices 1022, 1024 via the access network 1016, which enable the set-top box devices 1022, 1024 to provide functions, such as display, messaging, processing of IPTV data and VOD material, validate coupons, etc. In a particular embodiment, the OSS/BSS gateway 1058 includes operation systems and support (OSS) data, as well as billing systems and support (BSS) data. In one embodiment, the OSS/BSS gateway 1058 can provide or restrict access to an OSS/BSS server 1060 that stores operations and billing systems data. Further the OSS/BSS server 1060 may include coupon validation and processing systems, such as one or more elements of an on-demand provider system, such as the on demand provider system 118 of FIG. 1, or the on-demand provider system 324 of FIG. 3.

The second APP switch 1054 can be coupled to a domain controller 1062 that provides Internet access, for example, to users at their computers 1064 via the public network 1012. For example, the domain controller 1062 can provide remote Internet access to IPTV account information, e-mail, personalized Internet services, or other online services via the public network 1012. In addition, the second APP switch 1054 can be coupled to a subscriber and system store 1066 that includes account information, such as account information that is associated with users who access the IPTV system 1000 via the private network 1010 or the public network 1012. In an illustrative embodiment, the subscriber and system store 1066 can store subscriber or customer data and create subscriber or customer profiles that are associated with IP addresses of corresponding set-top box devices 1022, 1024.

In a particular embodiment, the application tier 1004 can include a client gateway 1014 that communicates data directly to the client-facing tier 1002. In this embodiment, the client gateway 1014 can be coupled directly to the CFT switch 1042. The client gateway 1014 can provide user access to the private network 1010 and the tiers coupled thereto. In an illustrative embodiment, the set-top box devices 1022, 1024 can access the IPTV system 1000 via the access network 1016, using information received from the client gateway 1014. User devices can access the client gateway 1014 via the access network 1016, and the client gateway 1014 can allow such devices to access the private network 1010 once the devices are authenticated or verified. Similarly, the client gateway 1014 can prevent unauthorized devices, such as hacker computers or stolen set-top box devices from accessing the private network 1010, by denying access to these devices beyond the access network 1016.

For example, when the first representative set-top box device 1022 accesses the client-facing tier 1002 via the access network 1016, the client gateway 1014 can verify subscriber information by communicating with the subscriber and system store 1066 via the private network 1010. Further, the client gateway 1014 can verify billing information and status by communicating with the OSS/BSS gateway 1058 via the private network 1010. In one embodiment, the OSS/BSS gateway 1058 can transmit a query via the public network 1012 to the OSS/BSS server 1060. After the client gateway 1014 confirms subscriber and/or billing information, the client gateway 1014 can allow the set-top box device 1022 to access IPTV content and VOD content at the client-facing tier 1002. If the client gateway 1014 cannot verify subscriber information for the set-top box device 1022, e.g., because it is connected to an unauthorized twisted pair, the client gateway 1014 can block transmissions to and from the set-top box device 1022 beyond the access network 1016.

As indicated in FIG. 10, the acquisition tier 1006 includes an acquisition tier (AQT) switch 1068 that communicates with the private network 1010. The AQT switch 1068 can also communicate with the operations and management tier 1008 via the public network 1012. In a particular embodiment, the AQT switch 1068 can be coupled to a live acquisition server 1070 that receives or acquires television content, movie content, advertisement content, other video content, or any combination thereof, from a broadcast service 1072, such as a satellite acquisition system or satellite head-end office. In a particular embodiment, the live acquisition server 1070 can transmit content to the AQT switch 1068, and the AQT switch 1068 can transmit the content to the CFT switch 1042 via the private network 1010.

In an illustrative embodiment, content can be transmitted to the D-servers 1044, where it can be encoded, formatted, stored, replicated, or otherwise manipulated and prepared for communication from the video server(s) 1050 to the set-top box devices 1022, 1024. The CFT switch 1042 can receive content from the video server(s) 1050 and communicate the content to the CPE 1018, 1020 via the access network 1016. The set-top box devices 1022, 1024 can receive the content via the CPE 1018, 1020, and can transmit the content to the television monitors 1026, 1028. In an illustrative embodiment, video or audio portions of the content can be streamed to the set-top box devices 1022, 1024.

Further, the AQT switch 1068 can be coupled to a video-on-demand importer server 1074 that receives and stores television or movie content received at the acquisition tier 1006 and communicates the stored content to the VOD server 1048 at the client-facing tier 1002 via the private network 1010. Additionally, at the acquisition tier 1006, the video-on-demand (VOD) importer server 1074 can receive content from one or more VOD sources outside the IPTV system 1000, such as movie studios and programmers of non-live content. The VOD importer server 1074 can transmit the VOD content to the AQT switch 1068, and the AQT switch 1068, in turn, can communicate the material to the CFT switch 1042 via the private network 1010. The VOD content can be stored at one or more servers, such as the VOD server 1048.

When users issue requests for VOD content via the set-top box devices 1022, 1024, the requests can be transmitted over the access network 1016 to the VOD server 1048, via the CFT switch 1042. Upon receiving such requests, the VOD server 1048 can retrieve the requested VOD content and transmit the content to the set-top box devices 1022, 1024 across the access network 1016, via the CFT switch 1042. The set-top box devices 1022, 1024 can transmit the VOD content to the television monitors 1026, 1028. In an illustrative embodiment, video or audio portions of VOD content can be streamed to the set-top box devices 1022, 1024.

FIG. 10 further illustrates that the operations and management tier 1008 can include an operations and management tier (OMT) switch 1076 that conducts communication between the operations and management tier 1008 and the public network 1012. In the embodiment illustrated by FIG. 10, the OMT switch 1076 is coupled to a TV2 server 1078. Additionally, the OMT switch 1076 can be coupled to an OSS/BSS server 1060 and to a simple network management protocol (SNMP) monitor 1080 that monitors network devices within or coupled to the IPTV system 1000. In a particular embodiment, the OMT switch 1076 can communicate with the AQT switch 1068 via the public network 1012.

In an illustrative embodiment, the live acquisition server 1070 can transmit content to the AQT switch 1068, and the AQT switch 1068, in turn, can transmit the content to the OMT switch 1076 via the public network 1012. In this embodiment, the OMT switch 1076 can transmit the content to the TV2 server 1078 for display to users accessing the user interface at the TV2 server 1078. For example, a user can access the TV2 server 1078 using a personal computer (PC) 1064 coupled to the public network 1012.

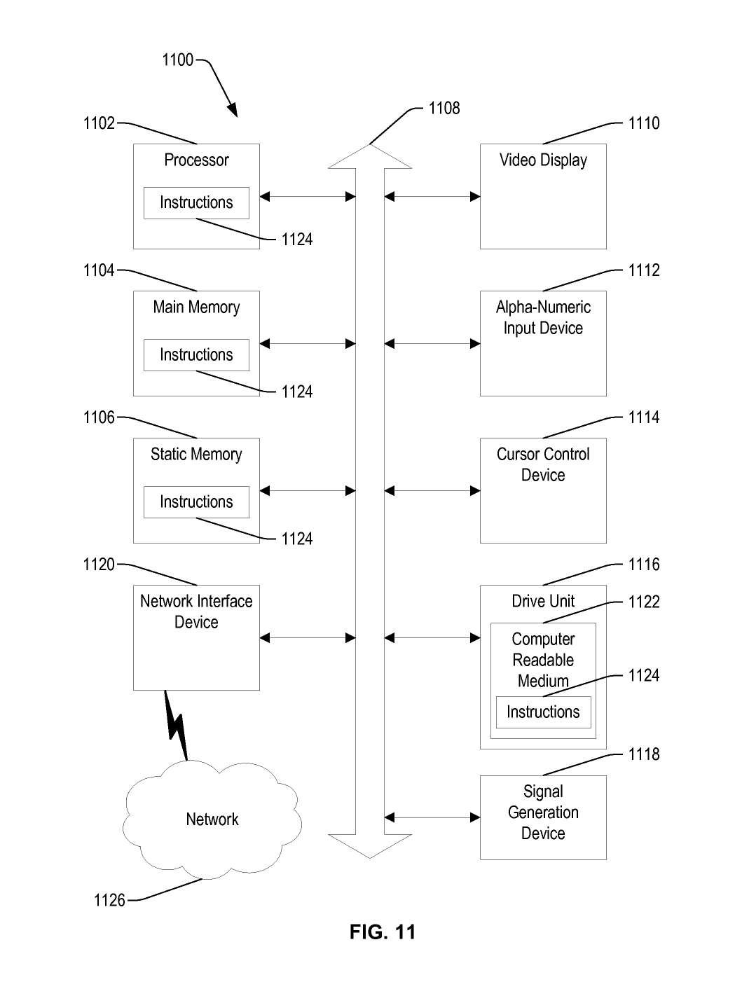

Referring to FIG. 11, an illustrative embodiment of a general computer system is shown and is designated 1100. The computer system 1100 may include a set of instructions that can be executed to cause the computer system 1100 to perform any one or more of the methods or computer based functions disclosed herein. The computer system 1100 may operate as a standalone device or may be connected, e.g., using a network, to other computer systems or peripheral devices. For example, the computer system 1100 may include or be included within any one or more of the user devices 102 and the on-demand provider system 118 described with reference to FIG. 1. In another example, the computer system 1100 may include or be included within any one or more of the user devices 302, the portals 312, the on-demand provider system 324, the operator terminal 326, the databases 330, 334, 344, 360, 364, the VHO 352, and the billing engine 368 described with reference to FIG. 3. In still another example, the computer system 1100 may include or be included within any one or more of the marketing systems 402, the user device 404, the coupon processing system 406, the subscriber database 408, the coupon inventory system 410, the billing event processing system 412, the billing engine 414, the metadata database 416 and the IPTV system 418 described with reference to FIG. 4.

In a networked deployment, the computer system 1100 may operate in the capacity of a server or as a client user computer in a server-client user network environment, or as a peer computer system in a peer-to-peer (or distributed) network environment. The computer system 1100 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a web appliance, or any other machine capable of executing a set of instructions (sequential or otherwise) that specify actions to be taken by that machine. In a particular embodiment, the computer system 1100 may be implemented using electronic devices that provide video, audio, or data communication. Further, while a single computer system 1100 is illustrated, the term “system” shall also be taken to include any collection of systems or sub-systems that individually or jointly execute a set, or multiple sets, of instructions to perform one or more computer functions.

As illustrated in FIG. 11, the computer system 1100 may include a processor 1102, e.g., a central processing unit (CPU), a graphics processing unit (GPU), or both. Moreover, the computer system 1100 may include a main memory 1104 and a static memory 1106, which can communicate with each other via a bus 1108. As shown, the computer system 1100 may further include a video display unit 1110, such as a liquid crystal display (LCD), a projection television system, a flat panel display, or a solid state display. Additionally, the computer system 1100 may include an input device 1112, such as a keyboard, and a cursor control device 1114, such as a mouse. The computer system 1100 may also include a disk drive unit 1116, a signal generation device 1118, such as a speaker or remote control, and a network interface device 1120. Some computer systems 1100 may not include an input device (e.g., a server may not include an input device).

In a particular embodiment, as depicted in FIG. 11, the disk drive unit 1116 may include a computer-readable non-transitory storage medium 1122 in which one or more sets of instructions 1124, e.g. software, can be embedded. Further, the instructions 1124 may embody one or more of the methods or logic as described herein. In a particular embodiment, the instructions 1124 may reside completely, or at least partially, within the main memory 1104, the static memory 1106, and/or within the processor 1102 during execution by the computer system 1100. The main memory 1104 and the processor 1102 also may include computer-readable non-transitory storage media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by the computer system 1100. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a computer-readable non-transitory storage medium that stores instructions 1124 or receives, stores and executes instructions 1124 responsive to a propagated signal, so that a device connected to a network 1126 may communicate voice, video or data over the network 1126. Further, the instructions 1124 may be transmitted or received over the network 1126 via the network interface device 1120.

While the computer-readable non-transitory storage medium is shown to be a single medium, the term “computer-readable non-transitory medium” includes a single medium or multiple media, such as a centralized or distributed database, and/or associated caches and servers that store one or more sets of instructions. The term “computer-readable non-transitory medium” shall also include any medium that is capable of storing instructions for execution by a processor or that cause a computer system to perform any one or more of the methods or operations disclosed herein.

In a particular non-limiting, exemplary embodiment, the computer-readable non-transitory storage medium may include a solid-state memory such as a memory card or other package that houses one or more non-volatile read-only memories. Further, the computer-readable non-transitory storage medium may be a random access memory or other volatile re-writable memory. Additionally, the computer-readable non-transitory storage medium may include a magneto-optical or optical medium, such as a disk or tapes or other storage device. Accordingly, the disclosure is considered to include any one or more of a computer-readable non-transitory storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
receiving a coupon validation request associated with a user account;
determining whether a coupon is valid based at least partially on the coupon validation request;
when the coupon is valid, adding coupon data associated with the coupon to a valid coupon list associated with the user account;
receiving transaction data including information descriptive of at least one transaction associated with the user account;
automatically comparing the transaction data to the valid coupon list to determine whether at least one coupon identified in the valid coupon list is applicable to the at least one transaction;
when two or more coupons identified in the valid coupon list are applicable to the at least one transaction, automatically selecting a first coupon to apply to the at least one transaction based on priorities associated with the two or more coupons; and
automatically applying the first coupon to the at least one transaction.

2. The method of claim 1, wherein the first coupon is selected from the valid coupon list without user input.

3. The method of claim 1, wherein a priority is assigned to each of the two or more coupons by a coupon provider.

4. The method of claim 1, further comprising determining a priority associated with each coupon of the two or more coupons based on at least one of an expiration date of the coupon, a value of the coupon, a number of usages remaining of the coupon, and whether the coupon is associated with a specific asset or is associated with a plurality of assets.

5. The method of claim 1, wherein the coupon validation request is received from a mobile communication device associated with the user account.

6. The method of claim 1, wherein the coupon validation request is received from a computing device associated with the user account.

7. The method of claim 1, wherein the coupon validation request is received from a set top box device associated with the user account.

8. A non-transitory, computer-readable medium, comprising:
instructions executable by a processor to cause the processor to determine whether a coupon is valid based at least partially on a coupon validation request associated with a user account;
instructions executable by the processor to cause the processor to add coupon data associated with the coupon to a valid coupon list associated with the user account when the coupon is valid;
instructions executable by the processor to cause the processor to compare transaction data to the valid coupon list to determine whether at least one coupon identified in the valid coupon list is applicable to at least one transaction associated with the user account, wherein the transaction data includes information descriptive of the at least one transaction;
instructions executable by the processor to cause the processor to select a first coupon to apply to the at least one transaction based on a priority of two or more coupons identified in the valid coupon list that are applicable to the at least one transaction; and
instructions executable by the processor to cause the processor to apply the first coupon to the at least one transaction.

9. The non-transitory, computer-readable medium of claim 8, further comprising instructions executable by the processor to cause the processor to generate a bill associated with the user account, wherein the first coupon is applied to the at least one transaction during generation of the bill.

10. The non-transitory, computer-readable medium of claim 8, further comprising instructions executable by the processor, in response to determining that the coupon is valid, to cause the processor to generate a display identifying one or more assets that can be purchased at least partially using the coupon.

11. The non-transitory, computer-readable medium of claim 10, wherein the one or more assets include at least one of a right to access particular video-on-demand content and a right to access particular pay-per-view content.

12. A system, comprising:
at least one processor; and
at least one memory accessible to the at least one processor; the at least one memory including:
a coupon validation module executable by the at least one processor to determine whether a coupon is valid based at least partially on a coupon validation request associated with a user account and to add coupon data associated with the coupon to a valid coupon list associated with the user account when the coupon is valid;
a transaction module executable by the at least one processor to facilitate at least one transaction associated with the user account; and
a billing module executable by the at least one processor during generation of a bill associated with the user account to compare transaction data that includes information descriptive of the at least one transaction associated with the user account to the valid coupon list to determine whether at least one coupon identified in the valid coupon list is applicable to the at least one transaction, to select a particular coupon to apply to the at least one transaction based on a priority of two or more coupons identified in the valid coupon list that are applicable to the at least one transaction, and to apply the particular coupon to the at least one transaction.

13. The system of claim 12, further comprising a coupon entry module to receive the coupon validation request from a user, the coupon validation request including a coupon identifier identifying the coupon.

14. The system of claim 13, wherein the coupon identifier is input by the user from a paper coupon.

15. The system of claim 13, wherein the coupon identifier is selected by the user via a coupon selection user interface.

16. The system of claim 12, wherein the coupon validation module determines whether the coupon is valid in response to receiving the coupon validation request, wherein the transaction module facilities the at least one transaction in response to receiving a transaction request associated with the user account, and wherein the billing module selects the particular coupon and applies the particular coupon to the at least one transaction in response to expiry of a billing period.

17. The system of claim 12, wherein the billing module selects the particular coupon from the valid coupon list without user input.

18. The system of claim 12, wherein the coupon validation module determine whether the at least one coupon is valid based at least partially on a profile associated with the user account.

19. The system of claim 12, wherein the coupon validation module determines whether the at least one coupon is valid based at least partially on a time zone associated with the user account.

20. The system of claim 12, wherein the coupon validation module provides feedback to a device that sent the coupon validation request in response to determining whether the coupon is valid.
